(19) United States
(12) Patent Application Publication
(10) Pub. No.: US 2008/0204301 A1
(43) Pub. Date: Aug. 28, 2008

(54) PLUSH ENCASED REMOTE CONTROL TRANSMITTER

(76) Inventor: Kenneth P. Sandberg, Salinas, CA (US)

Correspondence Address: West & Associates, A PC, Suite 209, 2815 Mitchell Drive, Walnut Creek, CA, 94598, US

(21) Appl. No.: 11/679,129

(22) Filed: Feb. 26, 2007

(51) Int. Cl. G08C 19/12

(52) U.S. Cl. 341/176

(57) ABSTRACT

A novel plush type toy or cushion having an embedded transmitter that is powered by an internal battery pack is disclosed. The embedded transmitter is used to trigger a remote receiver that is attached to an electrical device. The act of squeezing this toy will activate the transmitter. The receiver will alter or toggle its state based on the signal received from the transmitter to affect the attached electrical appliance.

### FIELD OF THE INVENTION

The current disclosure relates to plush toys or cushions that have an embedded transmitter or transceiver that can remotely control a device such as lights or home theatre components. The remote control signal is activated by pressing or squeezing the plush toy or cushion.

### BACKGROUND

It is quite common for young children to be afraid of the dark when sleeping by themselves in their own room. Monsters under the bed and things that go bump in the night are familiar childhood phobias that many children have to endure before these fears are finally outgrown.

The use of nightlights or leaving a light on at bedtime are simple and time-honored methods to tackle this problem, and new, energy-efficient bulbs and LEDs have alleviated most of the concerns about wasting energy from leaving on a light all night. However, in most situations it is impractical or undesirable to brightly light up a room all night, and children that have an acute fear of the dark may find inadequate comfort from a nightlight.

In order to give children convenient and psychologically comforting access to the lights while lying in bed, a remote control device can be given to them for turning on the lights when they feel the need.

Radio Frequency (RF) transmitters and receivers have been known in the prior art for some time to control various electrical devices such as lights or garage doors. The transmitters typically take the form of a key FOB or plastic encased box with a button. These devices are typically carried in pockets or mounted on a surface such as a wall. Plug-in dimmers that plug into a standard AC outlet and can receive commands wirelessly via a compatible remote control are fairly common in the market. However, such remote controls may be hard to operate by a small child. The controls can also be easily misplaced in the bedding while the child is in bed, resulting in frantic searches in the dark.

U.S. Pat. Nos. 5,615,271, 5,493,618 to Stevens, et al. teaches an acoustic switch device that can remotely operate electrical appliances. The acoustic switch operates a first electrical appliance upon receipt of a first series of acoustic signals and operates a second electrical appliance upon receipt of a second series of acoustic signals that is different from the first series of acoustic signals. Such a device is marketed under the well-known trademark “The Clapper.” While the Clapper can remotely turn lights on an off while the user is in bed (by clapping his hands together to make a clapping sound) without the use of an easily misplaced remote control, this can be impractical for use with small children afraid of the dark. The loud clapping required to turn the device on and off would be disturbing to others trying to sleep in the vicinity, and constant clapping will become a nuisance very quickly.

In order to wean children off their fear of the dark, a novel device is desired that can comfort and calm them at bedtime, while giving them a sense of control over their surroundings.

Such a device would allow children to control a light source remotely while lying in bed, and assist children to learn how to sleep by themselves without constant adult supervision. The device can also optionally be configured to send a remote signal to an adult guardian in another room.

It is also desired that such a device be adaptable for use and be attractive to adults. Such a device can replace easy to misplace remote controls for televisions or home theatres, while still being easy to carry.

Finally, it should have an appealing appearance, and should feel soft and comfortable to hold. It can provide a soothing and relaxing experience to the holder, adults and children alike.

Previously, other types of devices have been embedded within plush toys to provide an assortment of functionality. Most often, various toy makers have mounted sound making devices within such toys to either play music, mimic talking, or create other miscellaneous sounds by squeezing the toy. Some toy makers have also embedded devices that cause the toy itself to light up. However, no one has previously combined a wireless transmitter with a plush toy to control common electrical devices remotely.

### SUMMARY OF THE INVENTION

A novel plush type toy or cushion having an embedded transmitter that is powered by an internal battery pack is disclosed. The embedded transmitter is used to trigger a remote receiver that is attached to an electrical device. The act of squeezing this toy will activate the transmitter. The receiver will alter or toggle its state based on the signal received from the transmitter to affect the attached electrical appliance. One purpose of this toy is to allow a person to activate (i.e. turn on or off a lamp) an appliance from a distance by simply applying pressure to the toy.

By encasing the transmitter within a plush toy, the remote control can appeal to specific audiences, such as women and children. A cushion may also be used. Licensed characters, team mascots or team logos can be employed on the exterior to appeal to fans. In addition, encasing the transmitter in a plush object makes it easier to locate and easier to operate, especially for small children. As such, the device should be constructed in a three dimensional shape, be deformable, soft to the touch, and pliable.

The act of embedding the transmitter within a plush toy or cushion is designed to hide the functionality from view, have it appeal to a much younger audience, and make it easier to trigger by someone by a simple squeeze of the toy rather than fumbling with buttons. The device can help children who are afraid of the dark cope with the process of entering an unlighted room, or going to bed on their own, by providing them with the comfort and ability to turn on an appliance such as light when they see the need to do so. Using a plush toy as a means to control an appliance such as a lamp builds upon the fact that many children own and carry about such toys as a form of comfort. This device builds upon this fact to provide an additional level of comfort when their fear of the dark is being considered.

### BRIEF DESCRIPTION OF THE DRAWINGS

FIG. 1 depicts a front view of an embodiment of the device utilizing a plush toy.

FIG. 2 depicts a transmitter switch and battery pack according to one embodiment of the invention.

FIG. 3 depicts the transmitter switch and battery back being installed inside the plush toy.

FIG. 4 depicts a receiver according to one embodiment of the remote control.

### DETAILED DESCRIPTION

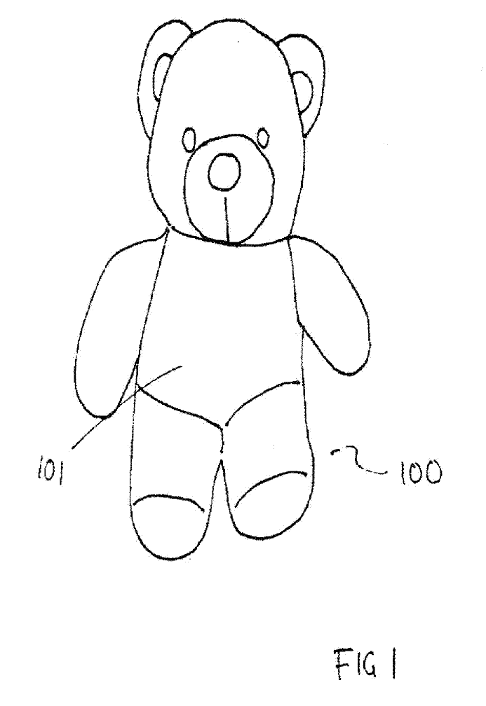

FIG. 1 depicts a front view of an embodiment of the novel remote control (hereinafter “remote control”) utilizing a plush-type toy exterior 100, in this case a teddy bear. The teddy bear is used for illustrative purposes and is not meant to be limiting. Any plush-type toy or cushion may be used to house the transmitter and battery pack within, as long as it is of a suitable size and is pleasing to the touch. The toy or pillow should be sized so that it can be carried or moved about with ease. If the remote control is to be used with small children, care should be given that a child-safe toy is used. In a preferred embodiment of the remote control, a plush toy is provided along with the transmitter and battery pack to ensure that the electrical components can fit properly inside the toy or pillow and that the switch will be properly activated when the toy is squeezed. In other embodiments, the end-user can change or replace the toy by removing the electrical components and installing them in a toy of their choice.

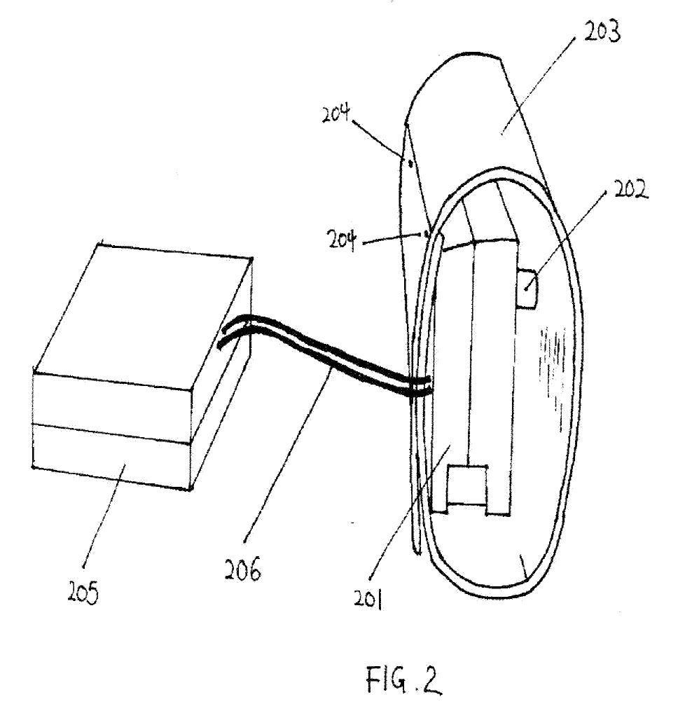

FIG. 2 depicts the transmitter switch and battery compartment according to one embodiment of the remote control. A transmitter 201 with an activation switch 202 is provided. In a preferred embodiment of the device, a RF transmitter is used in conjunction with a RF receiver to provide the capability of non-directional remote control. The RF transmitter should be capable of transmitting a signal with a range of 20 to 30 feet, suitable for operating devices remotely within most rooms. To avoid interference, the 2.4 Ghz band or higher may be used. In further embodiments of the remote control, any transmitter/receiver combination known or convenient that can provide remote control capabilities without requiring the plush toy to be in line-of-sight with the receiver device can be used. In further embodiments with use with televisions and home theatre components, an infrared or similar transmitter may be used.

Depressing the activation switch 202 activates the transmitter 201 to transmit a signal that can be picked up by a compatible receiver. In situations where more than one of the novel remote controls are to be used in close proximity, an end-user changeable channel or RFID setting is desired to avoid inadvertent interference from another remote. In the embodiment shown in FIG. 2, a single activation switch 202 is provided. In further embodiments of the remote control, additional activation switches located on different axis may be provided to give the remote control greater sensitivity to the plush toy exterior being depressed. This may be employed separately or in conjunction with the sheath discussed below.

In the embodiment shown in FIG. 2, the transmitter 201 and activation switch 202 are encased in a sheath 203 made from a material that can spring back to its original shape when compressed. In its normal uncompressed form, the sheath prevents the activation switch 202 from being depressed accidentally and activating the transmitter. A second purpose of this sheath is to increase the effective surface area of the activation switch 202, so that when the plush toy is squeezed in the general area where the switch is located, it would activate the transmitter. For example, if the transmitter is installed inside the body 101 of the teddy bear 100 shown in figure one, a simple squeeze in the body area, whether from the front, back or side of the toy, would activate the switch.

In the embodiment shown, the sheath has a generally cylindrical shape and is constructed from a sheet made from light pliable plastic. The sheet is curled around the transmitter 201 and switch 202 and fastened by fasteners 204 to form the sheath 203. In other embodiments, the sheath 203 may be constructed of any material known or convenient that can spring back after being compressed, including metal sheets, plastics, gels or rubber. In further embodiments of the device, the entire transmitter and switch may be encased in a sphere of gel, which would allow the switch to be activated when the gel is compressed in any direction.

The transmitter 201 is powered by batteries housed in a battery compartment 205, which supplies electrical power via wires 206 to the transmitter circuitry. In further embodiments of the remote control, the battery compartment may be integrated with the transmitter housing.

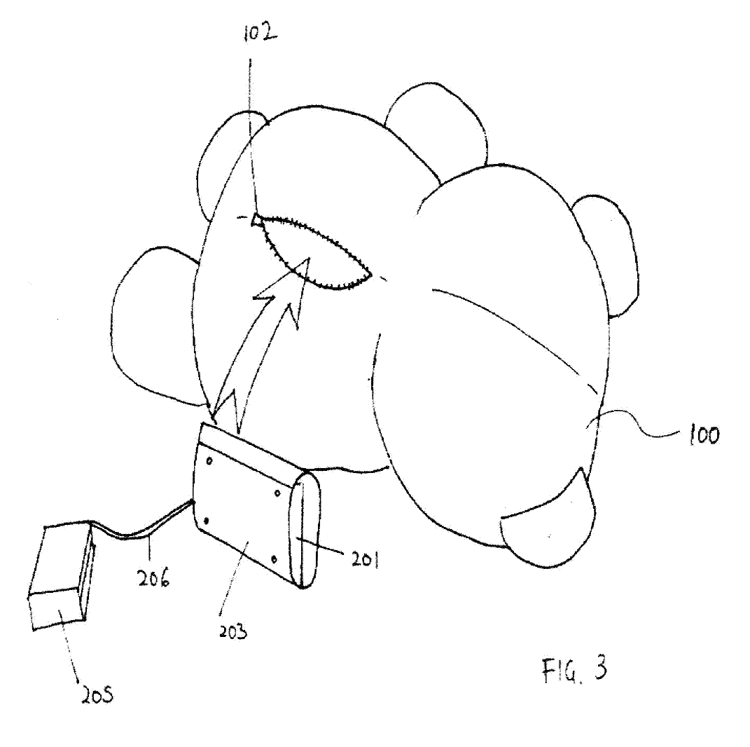

Refer to FIG. 3 which depicts a backside of the plush toy shown in FIG. 1. The transmitter assembly 201, 202, 203 and battery compartment 205 can be installed in the back of the plush teddy bear toy. A simple zipper, Velcro®, button or similar opening 102 can be used to access the innards of the toy to facilitate the changing of batteries. The battery compartment 205, transmitter 201 and sheath 202 can be simply installed in a cavity in the stuffing of the toy, no special mechanism or structure is needed to hold the electrical components in place as long as there is sufficient stuffing to prevent the components from moving about inside the toy. Alternatively, the battery compartment can be installed in a location inside the toy separate from the transmitter so that the components have less concentrated bulk inside the plush toy.

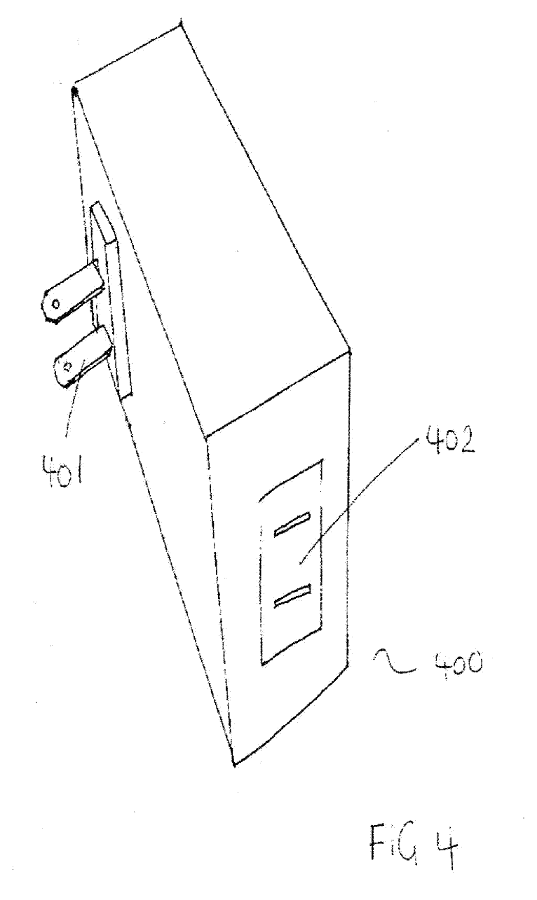

FIG. 4 depicts a receiver 400 according to one embodiment of the remote control. The receiver encompasses circuitry capable of receiving a signal from the transmitter. It has a standard electrical plug 401 designed to be plugged into a standard wall outlet. Alternate embodiments can be wired into a locale's electrical circuit. In either case, the purpose of the receiver is to alter or toggle the state of an attached electrical appliance (such as a lamp) when triggered by actuation of the transmitter embedded in the plush toy. Units that are plugged into a wall socket will have an external socket 402 to facilitate the plugging in of an electrical appliance. In embodiments of the remote control meant for controlling home theatre components such as a DVD player, television or cable box, a separate receiver is not needed.

To operate the novel remote control discussed in FIGS. 1-4, the receiver is plugged into a standard wall outlet and an electrical appliance such as a lamp is plugged into its external socket. To toggle the lamp between the on and off states, the plush toy is squeezed in the general area where the internal transmitter switch is embedded. In the teddy bear depicted in FIG. 1, the body area is given a squeeze in order to activate the transmitter switch. The transmitter then transmits a signal which is received remotely by the receiver. Upon receiving the signal, the receiver toggles its state from passing the electrical current from the outlet to its external socket (into which the electrical appliance is plugged in) to turning the current off, and vice versa.

Using the novel remote control, a child can turn on and turn off a lamp plugged into the receiver remotely and in the “safety” of his or her bed. In order to encourage them to go to bed in the dark, the receiver can have a setting that turns the electrical appliance attached to its external socket off after a pre-determined period of time. Another possible variation would be to provide a transmitter switch with the capability to continuously transmit a signal to keep the lights lit only if the plush exterior is kept squeezed. When pressure is released from the plush exterior, the lights would turn off. With this variation, the lights will normally be off in the child's room, and only come on when the remote control is squeezed.

In the spirit of the disclosure made herein, the novel remote control can go beyond controlling lights via a receiver unit. Multiple switches can be embedded in different parts of the plush toy to activate volume and channel controls for a television or home theatre remote. These switches can be connected to a common transmitter unit, or each have separate transmitter units. By way of example, a user can increase a television's volume by squeezing the right paw of the teddy bear, and decrease the volume by squeezing the left one. Universal, programmable or learning remote control capabilities can program the transmitters to transmit compatible signals for the user's home theatre, security or lighting systems. This embodiment of the remote control can be a relaxing companion on the TV couch.

Although the invention has been described in conjunction with specific embodiments thereof, it is evident that many alternatives, modifications and variations will be apparent to those skilled in the art. Accordingly, the apparatus as described and hereinafter claimed is intended to embrace all such alternatives, modifications and variations that fall within the spirit and broad scope of the appended claims.

What is claimed is:

1. A remote control system for electrical appliances, comprising:
a transmitter capable of propagating a signal selected from the group consisting of electromagnetic, ultrasonic and infrared,
a power supply to supply power to said transmitter,
at least one switch to activate said transmitter to transmit said signal,
said transmitter, power supply and at least one switch being embedded in a soft exterior body,
wherein squeezing a part of said soft exterior body compresses said at least one switch to activate said transmitter to transmit said signal.

2. The remote control system of claim 1, further comprising:
a receiver capable of remotely receiving said signal from the transmitter,
said receiver having an electrical outlet capable of supplying power to an electrical appliance plugged into the receiver,
said receiver toggling the electrical state of said electrical outlet upon receipt of said signal.

3. The remote control device of claim 1, further comprising:
a compressible covering over said transmitter and at least one switch and embedded in said soft exterior body,
said compressible covering preventing the switch from being depressed in its uncompressed state, and depressing the switch to activate the transmitter in its compressed state.

4. The remote control device of claim 3, wherein said compressible covering is compressed by squeezing said soft exterior body.

5. The remote control device of claim 2, wherein said receiver further comprises capability to stop supplying power to an electrical appliance plugged into the receiver after a pre-set period of time of not receiving a signal from the transmitter.

6. The remote control device of claim 2, wherein said receiver further comprises capability to supply power to an electrical appliance plugged into the receiver only when a signal is continuously received from the transmitter.

7. The remote control device of claim 1, wherein said soft exterior body is in the form of a plush toy.

8. The remote control device of claim 1, wherein said soft exterior body is in the form of a cushion.

9. The remote control device of claim 1, further comprising at least two switches capable of activating the transmitter, each switch activating the transmitter to transmit a different signal.

10. The remote control device of claim 1, wherein said remote control device is capable of controlling audio-visual equipment.

11. The remote control device of claim 3, wherein said compressible covering has a generally cylindrical shape.

12. The remote control device of claim 3, wherein said compressible covering has a generally spherical shape.

13. The remote control device of claim 1, wherein said soft exterior body can be changed by the end user.

14. The remote control device of claim 11, wherein said compressible covering is constructed from a sheet made of light pliable plastic.

15. The remote control device of claim 12, wherein said compressible covering is made of a gelatinous substance.

16. The remote control device of claim 1, wherein said transmitter has an end-user changeable channel or RFID setting to avoid interference from another remote control device.

17. The remote control device of claim 1, wherein said soft exterior body is stuffed with a material chosen from the group consisting of cotton, cloth, foam and gel.
